(19) United States
(12) Patent Application Publication
(10) Pub. No.: US 2005/0008465 A1
(43) Pub. Date: Jan. 13, 2005

(54) Industrial truck with a lateral opening for removal of the battery

(76) Inventors: Marek Szymanski, Kleinmeinsdorf (DE); Michael Buchmann, Glinde (DE); Stephan Ballhausen, Hamburg (DE); Torsten Gerdes, Wentorf (DE)

Correspondence Address: William H. Logsdon;WEBB ZIESENHEIM LOGSDON ORKIN & HANSON, P.C., 700 Koppers Building, 436 Seventh Avenue, Pittsburgh, PA, 15219-1818, US

(21) Appl. No.: 10/651,292

(22) Filed: Aug. 28, 2003

(30) Foreign Application Priority Data
Sep. 6, 2002 (DE) 102 41 418.1

(51) Int. Cl. B60P 1/00

(52) U.S. Cl. 414/522

(57) ABSTRACT

An industrial truck, in particular a fork lift truck, has a battery compartment with a battery block (3) that can be moved in the horizontal direction relative to the battery compartment through a lateral opening in the battery compartment. A floor of the battery compartment is equipped with a roller conveyor (1). The roller conveyor (1) has two or more parts, wherein at least one part (1b) of the roller conveyor (1) can be moved out of the battery compartment such that the battery block (3) can be moved on the roller conveyor (1) all the way out of the industrial truck.

### CROSS REFERENCE TO RELATED APPLICATION

This application corresponds to German Application No. 102 41 418.1 filed Sep. 6, 2002, which is herein incorporated by reference in its entirety.

### BACKGROUND OF THE INVENTION

### 1. FIELD OF THE INVENTION

This invention relates to an industrial truck, such as a fork lift truck, with a battery compartment having a battery block that can be moved in a horizontal direction relative to the battery compartment through a lateral opening in the battery compartment. A floor of the battery compartment is equipped with a roller conveyor.

### 2. TECHNICAL CONSIDERATIONS

Industrial trucks with a lateral opening for removal of the battery block are frequently equipped with a roller conveyor on which the battery block can be moved by applying a relatively small amount of force. In known industrial trucks, to move the battery block all the way out of the battery compartment, an external roller conveyor is located next to the industrial truck and is then connected to the roller conveyor that is part of the industrial truck. External roller conveyors of this type can be installed in a fixed or stationary manner. The known art also describes roller conveyors that are movable by means of an overhead crane or another industrial truck, e.g., roller conveyors that are located on a manually operated lift truck. Systems of this type for changing battery blocks are used on industrial trucks of all types, for example, electric counterweighted fork lift trucks, reach trucks, high-shelf or low-shelf lift trucks. One disadvantage of this system for changing batteries with roller conveyors is that an external roller conveyor must always be kept available so that the battery block can be completely removed from the industrial truck.

Therefore, it is an object of the invention to provide an industrial truck of the general type described above but in which a battery can be changed without the need for an external roller conveyor.

### SUMMARY OF THE INVENTION

The invention teaches that the roller conveyor of the industrial truck includes two or more parts, wherein at least one part of the roller conveyor can be moved out of the battery compartment so that the battery block can be moved all the way out of the industrial truck on the roller conveyor. Once the battery block is outside the industrial truck, it can then be lifted directly, e.g., by means of a crane. No additional external roller conveyor is required. When the roller conveyor of the industrial truck is configured in two or more parts, one part always remains on or attached to the floor of the battery compartment. While the industrial truck is in operation, the remaining parts of the roller conveyor also remain inside the industrial truck. However, for replacement of the battery block, these remaining parts can also be realized in the form of an extension of the first part, so that the battery block can be moved all the way out of the industrial truck. A new battery block can then be inserted by performing the above operations in reverse order, i.e., the battery block can be placed on the extended part of the roller conveyor by means of a crane, for example, and can then be pushed into the battery compartment. The movable parts of the roller conveyor can also be moved into the battery compartment.

The roller conveyor can have a part that is permanently fixed to the vehicle and located in the vicinity of the floor of the battery compartment.

The roller conveyor likewise can have at least one movable part which, in a retracted position, is located in the vicinity of the floor of the battery compartment and can be extended into an extended position where it represents an extension of the fixed part.

In one advantageous development of the invention, on the movable part of the roller conveyor, a movable support can be provided with which the roller conveyor can be supported on a floor or road. With the support, the weight of a battery block located outside the industrial truck on the roller conveyor can be supported directly on the floor or road. This support is helpful because the weight of the heavy battery block could otherwise cause the industrial truck to tip over.

The movable part of the roller conveyor can have a stop which defines the limit position of the battery block outside the industrial truck on the roller conveyor. The stop ensures that the battery block does not roll beyond the end of the roller conveyor. However, an additional purpose of the stop is to define the position of the battery block in which the battery block is completely outside the industrial truck and can, therefore, be lifted safely.

In one particularly advantageous configuration, the stop can be movably located on the movable part of the roller conveyor, so that the battery block located in the limit position outside the industrial truck on the roller conveyor projects outwardly beyond the end of the roller conveyor. On the other hand, the stop can be movably located on the movable part of the roller conveyor so that when the movable part is in the retracted position the stop can be moved entirely inside the contour of the industrial truck. The movable stop makes possible a realization of the roller conveyor having a fixed part and only one movable part which is guided on the stationary part.

It is also advantageous if the stop is in the form of a handle for moving the movable part of the roller conveyor. The number of components of the roller conveyor is thereby minimized.

The required safety during operation of the industrial truck is guaranteed if the industrial truck has a retaining device that prevents the battery block from unintentionally or accidentally rolling out of the battery compartment.

The retaining device can be advantageously effectively connected with the roller conveyor so that it prevents the battery block from rolling out of the battery compartment only when the movable part of the roller conveyor is fully extended and supported on the floor or road. This arrangement also prevents mistakes in the operation of the roller conveyor, as might occur, for example, if the operator forgets to fold down the support or does not extend the roller conveyor all the way.

### BRIEF DESCRIPTION OF THE DRAWINGS

Additional advantages and features of the invention are explained in greater detail below on the basis of the exemplary embodiment illustrated in the accompanying schematic figures, in which like reference numbers identify like parts throughout:

FIG. 1 is an overhead view of an extended roller conveyor of an industrial truck; and

FIG. 2 is a side view of an extended roller conveyor of FIG. 1.

### DESCRIPTION OF THE PREFERRED EMBODIMENT

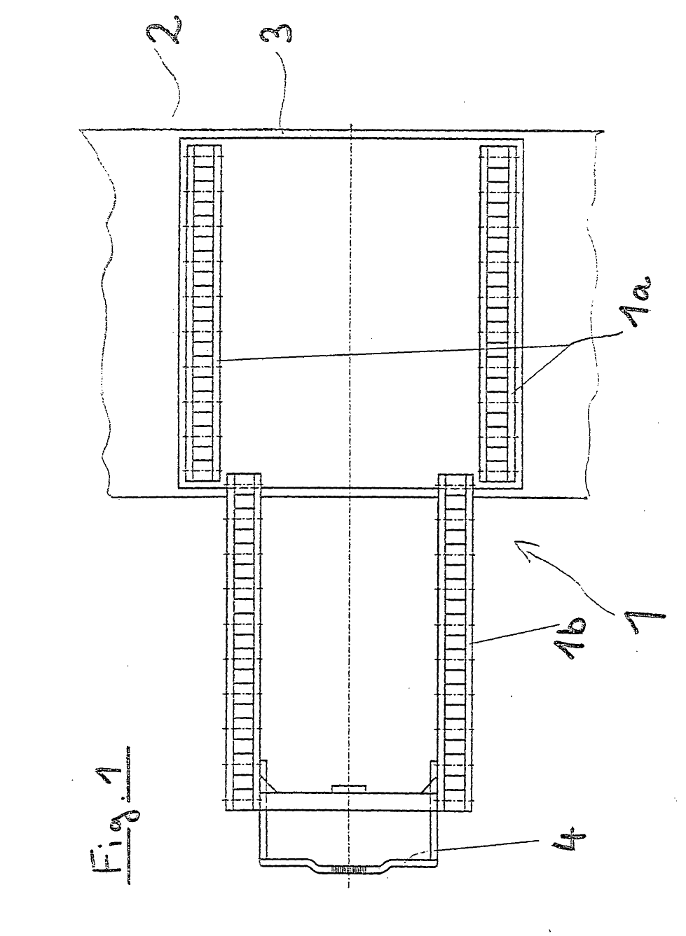

FIG. 1 shows an overhead view of an extended roller conveyor 1 in an industrial truck. The conveyor 1 includes a first part I a which is fixed in relation to the truck and a movable (second) part 1b. The part 1a which is fixed in relation to the truck is located entirely inside the body or contour 2 of the industrial truck. The drawing also shows the outlines of a battery block 3 supported on the roller conveyor 1 which is located in the battery compartment of the industrial truck. The movable part 1b of the roller conveyor is shown in its extended position (i.e., extending outside of the battery compartment).

The battery block 3 can be moved on the roller conveyor 1 out of the battery compartment (to the left in the drawing) as far as a stop 4, which is located on the movable part 1b. The stop 4 simultaneously acts as a handle for moving the movable part 1b. When the industrial truck is in operation, the movable part 1b and the stop 4 can be moved to the right in the drawing, so that they too are entirely inside the contour 2 of the industrial truck.

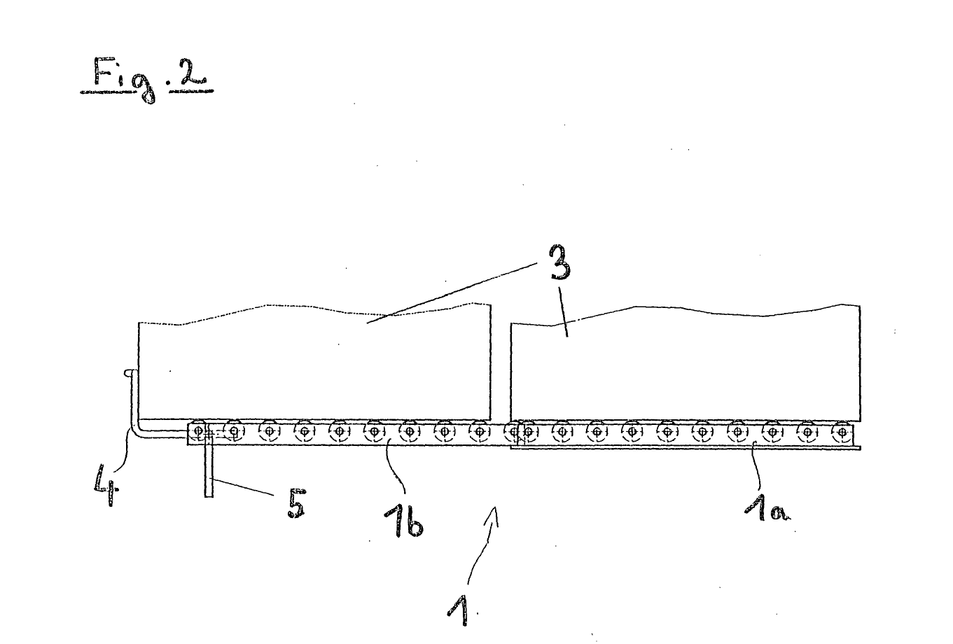

FIG. 2 is a side view of the roller conveyor 1 illustrated in FIG. 1. The battery block 3 is shown on the right in the position in which it is entirely inside the industrial truck (i.e., inside the battery compartment), and on the left in the position in which it is entirely outside the industrial truck (i.e., outside the battery compartment). The stop 4 prevents the battery block 3 from rolling off the outer end of the roller conveyor 1. A fold-down support 5 can also be fastened to the movable portion 1b of the roller conveyor 1 and can support the weight of the extended part 1b of the roller conveyor 1 and the battery block 3 on the floor or road when the battery block 3 is located on the roller conveyor 1b.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

1. An industrial truck, comprising:
a battery compartment having a floor;
a battery block movable in a lateral direction relative to the battery compartment through a lateral opening in the battery compartment; and
a roller conveyor attached to the floor of the battery compartment,
wherein the roller conveyor includes one or more parts, and
wherein the roller conveyor includes at least one movable part movable out of the battery compartment so that the battery block can be moved on the roller conveyor all the way out of the industrial truck.

2. The industrial truck as claimed in claim 1, wherein the roller conveyor includes a fixed part fastened in a stationary manner to the truck and located in the vicinity of the floor of the battery compartment.

3. The industrial truck as claimed in claim 2, wherein in a retracted position the at least one movable part is located in the vicinity of the floor of the battery compartment and can be moved into an extended position in an extension of the fixed part fastened in a stationary manner to the vehicle.

4. The industrial truck as claimed in claim 1, including a movable support mounted on the movable part of the roller conveyor and configured to support the roller conveyor on a floor or road.

5. The industrial truck as claimed in claim 1, wherein the movable part of the roller conveyor includes a stop which defines a limit position of the battery block when the battery block is located outside the industrial truck on the roller conveyor.

6. The industrial truck as claimed in claim 5, wherein the stop is movably located on the movable part of the roller conveyor, such that when the battery block is located in the limit position outside the industrial truck on the roller conveyor, the battery block extends outwardly beyond an outer end of the roller conveyor.

7. The industrial truck as claimed in claim 5, wherein the stop is movably located on the movable part of the roller conveyor, such that in a retracted position of the movable part the stop can be moved entirely inside a contour of the industrial truck.

8. The industrial truck as claimed in claim 5, wherein the stop includes a handle configured to move the movable part of the roller conveyor.

9. The industrial truck as claimed in claim 1, wherein the industrial truck includes a retaining device configured to prevent the battery block from unintentionally or accidentally rolling out of the battery compartment.

10. The industrial truck as claimed in claim 9, wherein the retaining device is effectively connected with the roller conveyor so that the battery block can roll all the way out of the battery compartment only when the roller conveyor is extended all the way and the movable part is supported on the floor or road.

11. The industrial truck as claimed in claim 3, including a movable support mounted on the movable part of the roller conveyor and configured to support the roller conveyor on a floor or road.

12. The industrial truck as claimed in claim 2, wherein the movable part of the roller conveyor includes a stop which defines a limit position of the battery block when the battery block is located outside the industrial truck on the roller conveyor.

13. The industrial truck as claimed in claim 3, wherein the movable part of the roller conveyor includes a stop which defines a limit position of the battery block when the battery block is located outside the industrial truck on the roller conveyor.

14. The industrial truck as claimed in claim 4, wherein the movable part of the roller conveyor includes a stop which defines a limit position of the battery block when the battery block is located outside the industrial truck on the roller conveyor.

15. The industrial truck as claimed in claim 12, wherein the stop is movably located on the movable part of the roller conveyor, such that when the battery block is located in the limit position outside the industrial truck on the roller conveyor the battery block extends outwardly beyond an outer end of the roller conveyor.

16. The industrial truck as claimed in claim 6, wherein the stop is movably located on the movable part of the roller conveyor, such that in a retracted position of the movable part the stop can be moved entirely inside a contour of the industrial truck.

17. The industrial truck as claimed in claim 6, wherein the stop includes a handle configured to move the movable part of the roller conveyor.

18. The industrial truck as claimed in claim 3, wherein the industrial truck includes a retaining device configured to prevent the battery block from unintentionally or accidentally rolling out of the battery compartment.

19. The industrial truck as claimed in claim 4, wherein the industrial truck includes a retaining device configured to prevent the battery block from unintentionally or accidentally rolling out of the battery compartment.

20. The industrial truck as claimed in claim 18, wherein the retaining device is effectively connected with the roller conveyor so that the battery block can roll all the way out of the battery compartment only when the roller conveyor is extended all the way and the movable part is supported on the floor or road.
